(19) United States
(12) Patent Application Publication
(10) Pub. No.: US 2026/0270032 A1
(43) Pub. Date: Sep. 10, 2026

(54) ORTHOGONAL SUB-BAND FULL DUPLEX

(71) Applicant: QUALCOMM Incorporated, San Diego, CA (US)

(72) Inventors: Igor GUTMAN, Hod HaSharon (IL); Juergen CEZANNE, Ocean Township, NJ (US); Tao LUO, San Diego, CA (US)

(21) Appl. No.: 19/160,835

(22) PCT Filed: Mar. 27, 2024
(86) PCT No.: PCT/US2024/021768

§ 371 Date: Aug. 28, 2025

(30) Foreign Application Priority Data
May 5, 2023 (IL) 302706

(51) Int. Cl. H04L 5/00

(52) U.S. Cl. CPC H04L 5/0098; H04L 5/0007

(57) ABSTRACT

Apparatus, methods, and computer program products for full-duplex (FD) communications are provided. An example method may include transmitting, during a time interval, a first transmission on a plurality of transmission (TX) subcarriers corresponding to a first TX component carrier (CC). The example method may further include receiving, during the time interval, a second transmission on a set of reception (RX) subcarriers corresponding to one or more RX CCs, where the set of RX subcarriers includes a respective plurality of RX subcarriers corresponding to each RX CC of the one or more RX CCs, and where the plurality of TX subcarriers and the set of RX subcarriers are interleaved in frequency such that the plurality of TX subcarriers is periodical in frequency and the set of RX subcarriers is periodical or non-periodical in frequency.

### TECHNICAL FIELD

The present disclosure relates generally to communication systems, and more particularly, to wireless communication systems with devices operating in a full-duplex (FD) mode, such as sub-band full-duplex (SBFD).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus (which may be a first network entity, such as a user equipment (UE) or a network node) are provided. The apparatus may include a memory and at least one processor coupled to the memory. The at least one processor may be configured to transmit, during a time interval, a first transmission on a plurality of transmission (TX) subcarriers corresponding to a first TX component carrier (CC). The at least one processor may be configured to receive, during the time interval, a second transmission on a set of reception (RX) subcarriers corresponding to one or more RX CCs, where the set of RX subcarriers includes a respective plurality of RX subcarriers corresponding to each RX CC of the one or more RX CCs, and where the plurality of TX subcarriers and the set of RX subcarriers are interleaved in frequency such that the plurality of TX subcarriers is periodical in frequency and the set of RX subcarriers is periodical or non-periodical in frequency.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4A is a diagram illustrating an example of full-duplex communication between network nodes and UEs and associated interferences.

FIG. 4B is a diagram illustrating an example of full-duplex communication between network nodes and UEs and associated interferences.

FIG. 4C is a diagram illustrating an example of full-duplex communication between network nodes and UEs and associated interferences.

FIG. 5A is a diagram illustrating an example of different types of full-duplex communication.

FIG. 5B is a diagram illustrating an example of different types of full-duplex communication.

FIG. 6 is a diagram illustrating examples of interference that may occur.

FIG. 7 is a diagram illustrating an example of transmitted signal and received signal in a magnitude (in decibel (dB) vs frequency (in Hertz (Hz)) graph.

FIG. 8 is a diagram illustrating example communications between a first wireless device and a second wireless device.

FIG. 9A is a diagram illustrating an example of tones used for power amplifier (PA) in and PA out.

FIG. 9B is a diagram illustrating an example of scatter plot of in-phase and quadrature component.

FIG. 10A is a diagram illustrating an example of tones used for PA in and PA out.

FIG. 10B is a diagram illustrating an example of tones used for PA in and PA out.

FIG. 11 is a diagram illustrating an example of different CCs used for FD transmission and reception.

FIG. 12A is a diagram illustrating an example processing of transmission and reception at a wireless device.

FIG. 12B is a diagram illustrating an example processing of transmission and reception at a wireless device.

FIG. 13 is a flowchart of a method of wireless communication.

FIG. 14 is a flowchart of a method of wireless communication.

FIG. 15 is a diagram illustrating an example of a hardware implementation for an example apparatus and/or network entity.

FIG. 16 is a diagram illustrating an example of a hardware implementation for an example network entity.

FIG. 17 is a diagram illustrating an example of a hardware implementation for a network entity.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

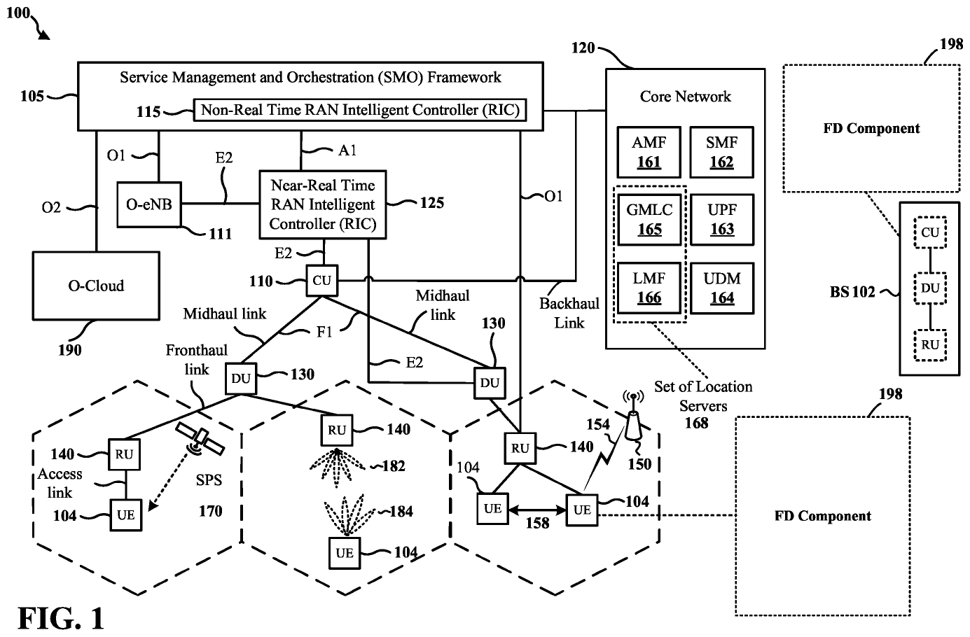

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHz), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU.

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 or the base station 102 may include a FD component 198. In some aspects, the FD component 198 may be configured to transmit, during a time interval, a first transmission on a plurality of TX subcarriers corresponding to a first TX CC. In some aspects, the FD component 198 may be further configured to receive, during the time interval, a second transmission on a set of RX subcarriers corresponding to one or more RX CCs, where the set of RX subcarriers includes a respective plurality of RX subcarriers corresponding to each RX CC of the one or more RX CCs, and where the plurality of TX subcarriers and the set of RX subcarriers are interleaved in frequency such that the plurality of TX subcarriers is periodical in frequency and the set of RX subcarriers is periodical or non-periodical in frequency. Reference to the set of RX subcarriers being periodical or non-periodical in frequency herein may refer to the set of RX subcarriers being periodical in frequency, non-periodical in frequency, or a combination thereof. For example, in some aspects, the set of RX subcarriers may be periodical in frequency. In other aspects, the set of RX subcarriers may be non-periodical in frequency. In other aspects, the set of RX subcarriers may be periodical and non-periodical in frequency, such as a first subset of the set of RX subcarriers being periodical in frequency and a second subset of the set of RX subcarriers being non-periodical in frequency.

Although the following description may be focused on 5G NR, the concepts described herein may be applicable to other similar areas, such as LTE, LTE-A, CDMA, GSM, and other wireless technologies.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

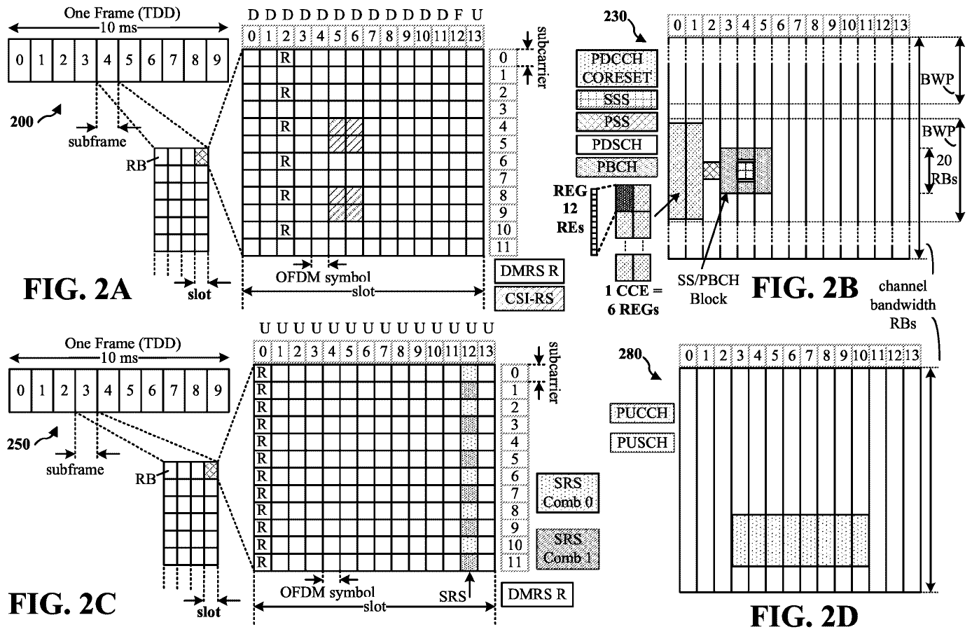

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI).

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

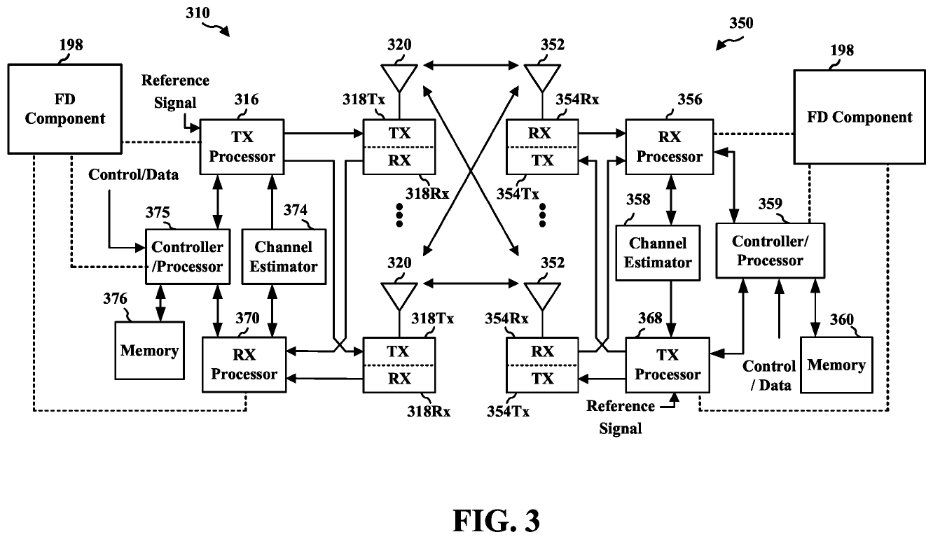

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with FD component 198 of FIG. 1.

At least one of the TX processor 316, the RX processor 370, and the controller/processor 375 may be configured to perform aspects in connection with FD component 198 of FIG. 1.

A communication network, such as a communication network based on 5G NR or other technologies, may support full-duplex operation in addition to half-duplex operation. Full-duplex operation may effectively increase the capacity of the communication network. For example, a base station in the communication network may support full-duplex operation while one or more UEs in the communication network may support half-duplex operation without supporting full-duplex operation. In another example, a base station in the communication network may support full-duplex operation and one or more UEs in the communication network may also support full-duplex operation. In another example, a base station in the communication network may support half-duplex operation without supporting full-duplex operation whereas one or more UEs in the communication network may support full-duplex operation.

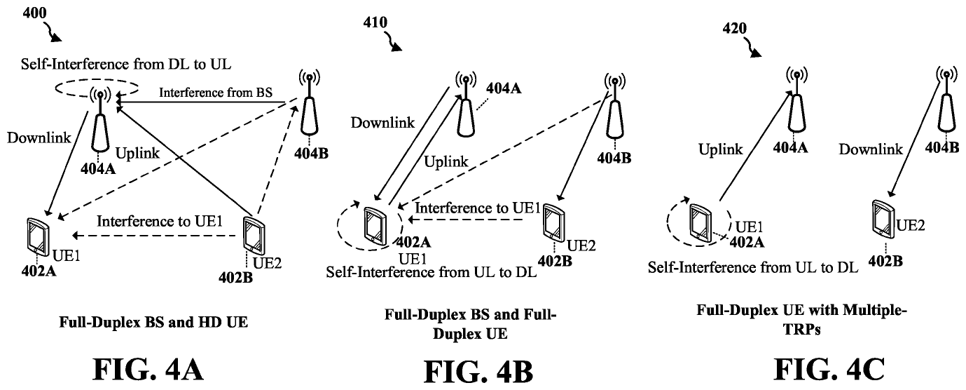

As illustrated in diagram 400 in FIG. 4A, two network nodes 404A and 404B operating in full-duplex mode and two UEs, UE1 402A and UE2 402B, operating in half-duplex mode are shown in the depicted example. While the network node 404A may be simultaneously transmitting downlink data to the UE1 402A and receiving uplink data from the UE2 402B, self-inference between the uplink reception and the downlink transmission at the network node 404A may occur. For example, a receiver at the network node may receive the transmitted downlink signal as interference to the uplink signal from the UE2 402B. In addition, because the UE1 402A may be receiving downlink data and the UE2 402B may be simultaneously transmitting uplink data, the transmission from UE2 402B may cause interference to the downlink signal being received by the UE1 402A. Moreover, because the network node 404B may also be receiving uplink data from the UE2 402B and transmitting downlink data to the UE1 402A, interference between the network nodes 404A and 404B may occur. Similarly, as illustrated in diagram 410 in FIG. 4B, when the two network nodes 404A and 404B and the two UEs UE1 402A and UE2 402B may each be operating in full-duplex mode, self-interference from uplink transmission to downlink reception at the UE (UE1 in the illustrated example) may also occur. Self-interference may occur from an uplink transmission of a UE to the downlink reception at the same UE even when the network node is not operating in full-duplex mode. As illustrated in diagram 420 in FIG. 4C, when the two network nodes 404A and 404B operate in a half-duplex mode, and the UEs UE1 402A and UE2 402B operate in a full-duplex mode, self-interference from uplink transmission of UEL to downlink reception at the UE1 402A may occur.

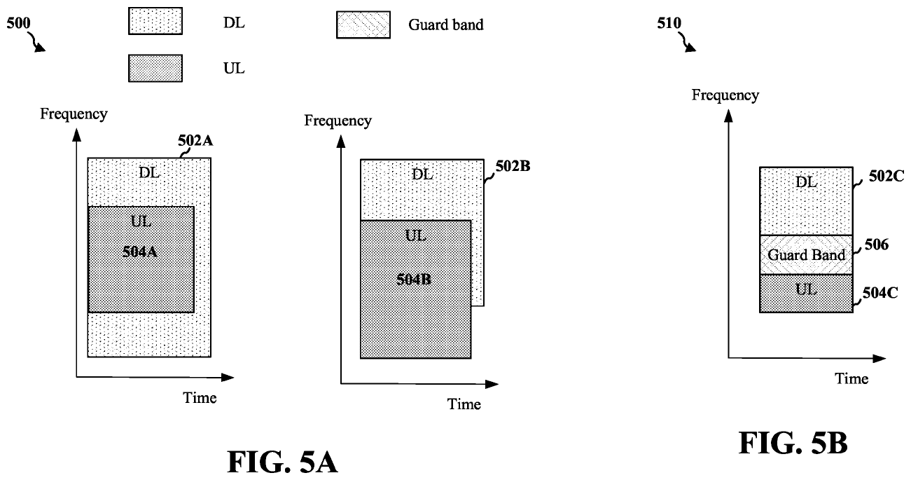

Full-duplex operation may be in the form of in-band full-duplex (IBFD) or SBFD. As illustrated in diagram 500 in FIG. 5A, for IBFD, the transmission and reception may occur at the same time, e.g., overlapping in time, and on the same frequency resource, e.g., using overlapping frequency resources. As illustrated in FIG. 5A, the IBFD time/frequency resources for downlink 502A and IBFD time/frequency resources for uplink 504A may be fully overlapped in some examples. In other examples, IBFD time/frequency resources for downlink 502B and IBFD time/frequency resources for uplink 504B may be partially overlapped, as illustrated in FIG. 5A.

For SBFD, as illustrated in diagram 510 in FIG. 5B, the transmission and reception may occur at the same time, e.g., at least partially overlapping in time, but on different frequency resources. In some aspects, the transmission and the reception may be completely overlapping in time. The downlink frequency resources 502C may be separated from the uplink frequency resources 504C in frequency domain. The separation may be referred to as a guard band 506, for example, and may provide a frequency gap or frequency separation between the downlink frequency resources 502C and the uplink frequency resources 504C.

FD communications may provide different benefits. For example, FD communication may lead to latency reduction. A network node may transmit send DL transmission to one UE while receiving UL transmission from another UE at the same time, which may reduce the potential UL or DL contention may result in reduced latency, especially in asymmetric links. There may also be reduction in routing latency. Adjacent hops (e.g., network nodes) may be activated simultaneously where an intermediate node operates in both downlink and uplink directions, which can substantially reduce the routing delay. FD communication may also improve overall throughput (TPUT) of the wireless communication system. To increase the overall TPUT without FD, a higher signal to noise ratio (SNR) may be used. As an example, for SNR higher than 10 dB, SNR to the factor of M may lead to a TPUT increase by factor of M. However, SNR might not be able to be increased indefinitely. To achieve a TPUT higher than a threshold that may be enabled by a highest SNR achieved, FD communication may be used.

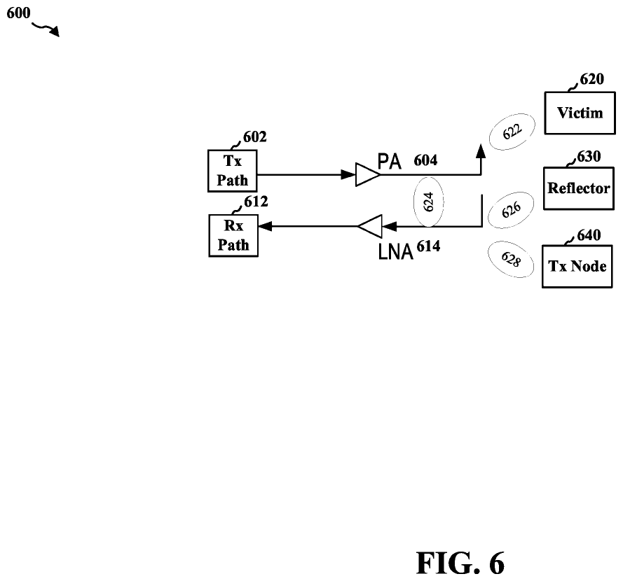

In FD communications, various types of interference may occur as described in connection with FIG. 4A, FIG. 4B, and FIG. 4C. As another example, FIG. 6 is a diagram 600 illustrating examples of interference that may occur. As illustrated in FIG. 6, on a RX path 612, there may be a low noise amplifier (LNA) 614 which may be connected to an antenna that receives a first transmission. On a TX path 602, there may be a PA 604 which may be connected to an antenna that transmits a second transmission. Because the first transmission and the second transmission may overlap in time, there may be direct self-interference 624 between the first transmission and the second transmission (e.g., the antenna connected to the RX path 612 may receive the leakage of the first transmission from the antenna connected to the TX path 602). The second transmission may cause cross-link interference 622 to a victim device 620 that is scheduled to receive a different transmission at an overlapping time. A reflector 630 which may reflect the first transmission may cause indirect self-interference 626 to the antenna connected to the RX path 612. A TX node 640 which may transmit a different transmission at an overlapping time may also cause interference 628 to the antenna connected to the RX path 612.

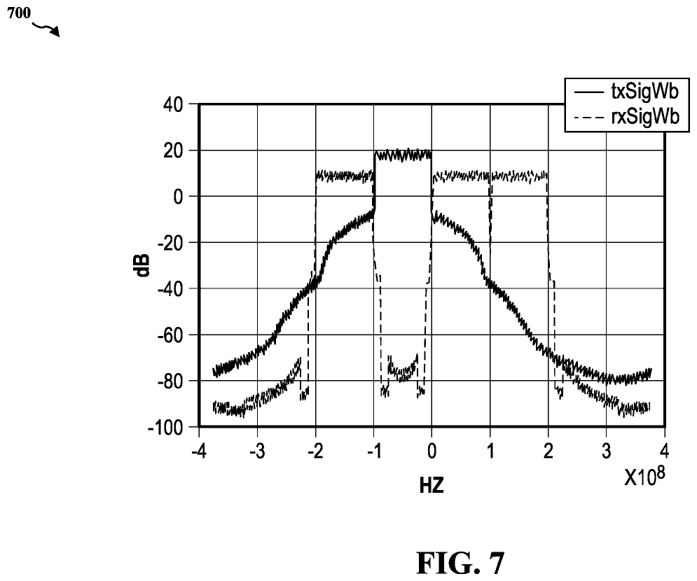

SBFD may be applied to FD communications to address potential direct self-interference. For example, among a set of CCs that may be used by a wireless device, a first set of CCs may be used for transmission (which may be referred to as TX CCs) and a second set of CCs may be used for reception (which may be referred to as RX CCs). However, spectrum leakage may still occur because a non-linear (NL) PA of the transmitting antenna may leak to adjacent RX CCs, which may degrade the RX performance. FIG. 7 is a diagram 700 illustrating an example of transmitted signal and received signal in a magnitude (in dB) vs frequency (in Hz) graph. As illustrated in FIG. 7, performance of CCs for receiving a transmission that are close to CCs may suffer dB loss compared to other CCs. It might be possible to deal with such dB loss by applying nonlinear interference cancelation (NLIC), which models the TX signal at the RX receiver and cancels the interference digitally. However, NLIC may be based on knowledge of the over-the-air (OTA) channel, which may be dynamic and non-constant for indirect SI caused by a reflector. In addition, for CI, the victim receiver may be aware of the transmitted signal of the aggressor and may not estimate or cancel the interference digitally. Aspects provided herein may address interferences for FD wireless devices based on (e.g., with or without signaling) interleaving the CCs used for FD transmission and the CCs used for reception in a non-adjacent manner, reducing the overall interference between the FD transmission and the FD reception that may overlap in time. In some aspects, a first set of CCs, which may be TX CCs used for FD transmission, and a second set of CCs, which may be RX CCs used for FD reception, may be interleaved based on interleaving property that may be maintained despite non-linearity. The interleaving property may include, by way of example, orthogonality. In some aspects, a plurality of TX subcarriers may correspond to a TX CC. In some aspects, a plurality of RX subcarriers may correspond to a RX CC.

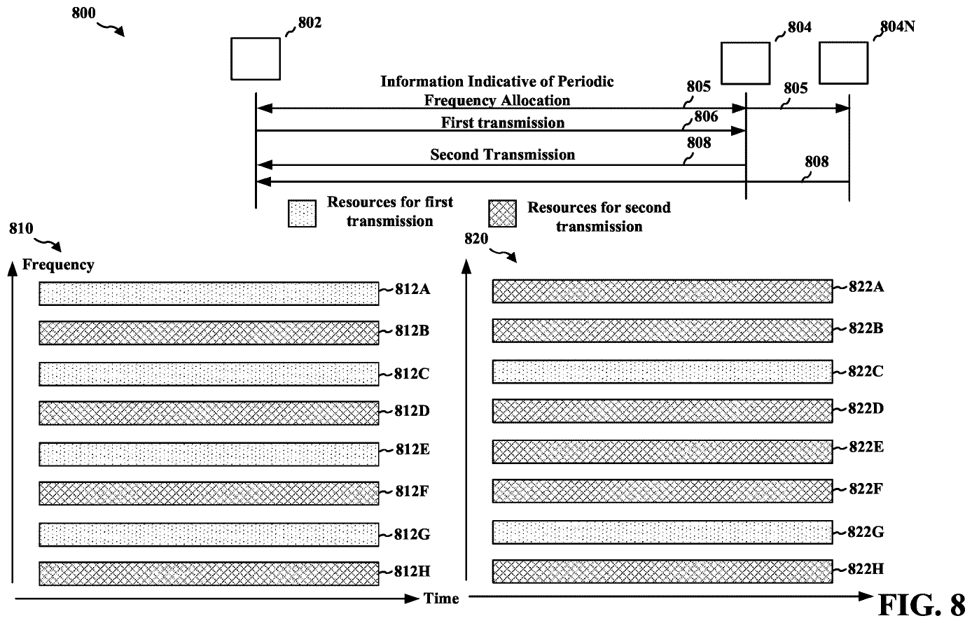

FIG. 8 is a diagram 800 illustrating example communications between a first wireless device 802 and a second wireless device 804. In some aspects, as illustrated in FIG. 8, the first wireless device may transmit a first transmission 806 and receive a second transmission 808 in an overlapping time period. In some aspects, the second transmission 808 may be transmitted from the second wireless device 804 to the first wireless device 802. In some aspects, the second transmission 808 may be transmitted from a third wireless device 804N to the first wireless device 802. In some aspects, the first transmission 806 may be transmitted from the first wireless device 802 to the second wireless device 804. As illustrated in example frequency allocation 810 and example frequency allocation 820 of FIG. 8, the CCs allocated for the first transmission and the second transmission may be non-neighboring (e.g., separated by at least one tone, a tone may refer to a part of a transport block bit(s) are allocated) in the frequency domain and may be interleaved (which means that among all CCs, each CC used for TX may be separated from another TX CC by a RX CC or each CC used for RX may be separated from another RX CC by a TX CC). The CCs allocated for the first transmission and the second transmission may be interleaved in frequency according to a frequency allocation, which may be communicated by communicating information 805 indicative of frequency allocation. The term “frequency allocation” may, in some aspects refer to a pattern in the frequency domain for allocating TX CCs and RX CCs. In some aspects, the frequency or tone difference between each of the allocated CCs or subcarriers that are periodic (e.g., between each allocated TX CC or subcarrier, or between each RX CC/subcarrier or TX CC/subcarrier) may be referred to as a “periodicity.” For example, if TX subcarriers are periodic in frequency, the frequency difference between each TX subcarrier may be based on the periodicity. In some aspects, there may be an allocation where TX CCs or TX subcarriers are interleaved with RX CCs or RX subcarriers in the frequency domain, where the TX allocation in the frequency domain is periodic and the RX allocation in frequency may be periodic or non-periodic (e.g., in any fashion where the RX CCs or RX subcarriers occupy periodic allocations tones where TX CCs or TX subcarriers do not exist). For example, the TX subcarriers may be allocated based on a periodicity of four where each TX subcarrier is separated by three other allocation tones. In some aspects, the RX subcarriers may be occupying any allocation tones not occupied by a TX subcarrier. In some aspects, the information 805 indicative of frequency allocation may be transmitted from the first wireless device 802 to the second wireless device 804. In some aspects, the information 805 indicative of frequency allocation may be transmitted from the second wireless device 804 to the first wireless device 802. In some aspects, the information 805 indicative of frequency allocation may be transmitted from the second wireless device 804 to another wireless device 804N. For example, as illustrated in example frequency allocation 810, a first subcarrier 812A may be used for the first transmission 806, a second subcarrier 812B may be used for the second transmission 808, a third subcarrier 812C may be used for the first transmission 806, a fourth subcarrier 812D may be used for the second transmission 808, a fifth subcarrier 812E may be used for the first transmission 806, a sixth subcarrier 812F may be used for the second transmission 808, a seventh subcarrier 812G may be used for the first transmission 806, and an eight subcarrier 812H may be used for the second transmission 808. In another example, as illustrated in example frequency allocation 820, a first subcarrier 822A may be used for the second transmission 808, a second subcarrier 822B may be used for the second transmission 808, a third subcarrier 822C may be used for the first transmission 806, a fourth subcarrier 822D may be used for the second transmission 808, a fifth subcarrier 822E may be used for the second transmission 808, a sixth subcarrier 822F may be used for the second transmission 808, a seventh subcarrier 822G may be used for the first transmission 806, and an eight subcarrier 822H may be used for the second transmission 808. In some aspects, the frequency difference between each of the subcarriers may be identical and may be based on the respective frequency allocation. In some aspects, the frequency difference between each of the subcarriers may be based on a total number of subcarriers in the bandwidth and a FFT window size associated with the subcarriers. In some aspects, the frequency difference between each of the CCs may be periodic in the frequency domain. In some aspects, the frequency difference between each of the CCs may be configured without signaling. In some aspects, the frequency difference between each of the CCs may be configured based on signaling between the first wireless device and the second wireless device, such as the information 805 indicative of frequency allocation. In some aspects, the frequency allocation may be configured to preserve orthogonality between the first transmission and the second transmission. In some aspects, according to the frequency allocation, TX subcarriers and RX subcarriers are interleaved in frequency such that no two subcarriers of the TX subcarriers are adjacent and the TX subcarriers may be periodic.

In some aspects, the first transmission 806 and the second transmission 808 may overlap in time. For example, the first transmission 806 and the second transmission 808 may completely overlap in time. In another example, in some aspects, the first transmission 806 and the second transmission 808 may partially overlap in time.

In some aspects, the first wireless device 802 may be a UE or a network node. In some aspects, the second wireless device 804 may be a UE or a network node. Each of the first transmission 806 and the second transmission 808 may be a DL transmission, a UL transmission, a sidelink transmission, or a backhaul transmission.

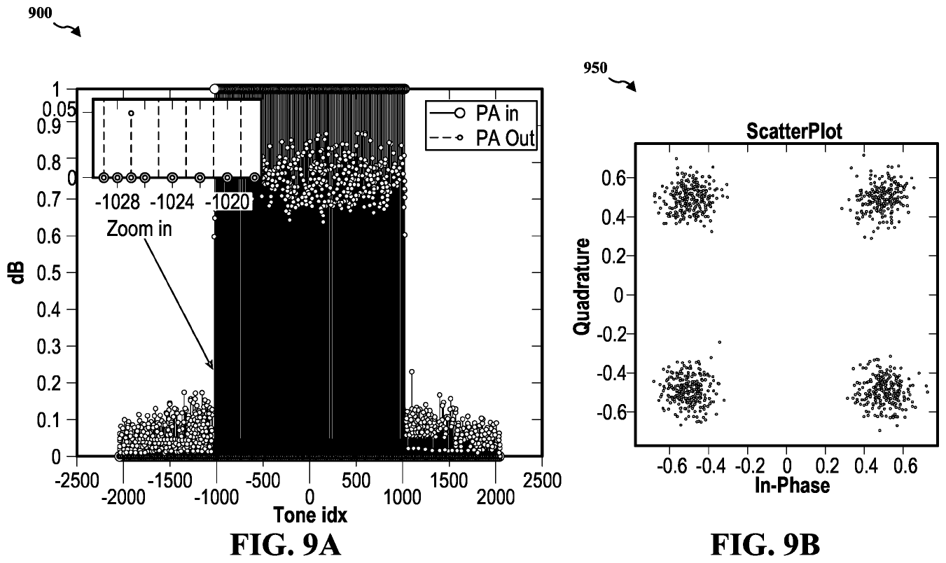

FIG. 9A is a diagram 900 illustrating an example of tones used for power amplifier (PA) in and PA out. As illustrated in FIG. 9A, the signal at the output of a PA may occupy the allocations as occupied at the PA's input if some properties are maintained: 1) the non-linearity (NL) is phase invariant, 2) the NL is time invariant, and the allocation is periodic and all on either odd or even tones (but not both). As illustrated in FIG. 9A, a periodicity associated with the allocation may be two.

FIG. 9B is a diagram 950 illustrating an example of scatter plot of in-phase and quadrature component. As illustrated in FIG. 9B, even though in-band distortion may be heavy, the frequency spectrum may remain in the same allocations that may be largely the same as the signal at the PA input.

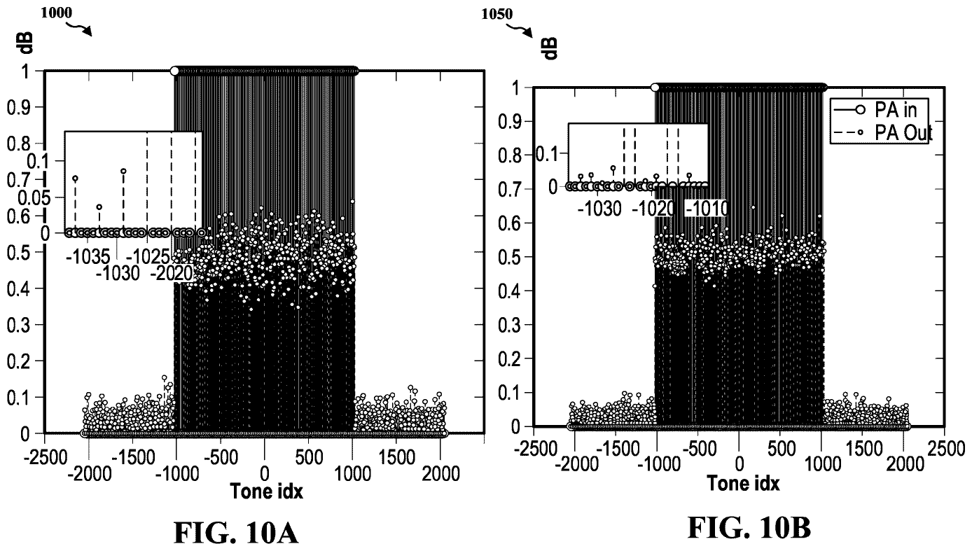

FIG. 10A is a diagram 1000 illustrating an example of tones used for PA in and PA out. As illustrated in FIG. 10A, a periodicity associated with the allocation may be four and the allocation may be largely maintained at both RX and TX.

FIG. 10B is a diagram 1050 illustrating an example of tones used for PA in and PA out. As illustrated in FIG. 10B, a periodicity associated with the allocation may be eight and the allocation may be largely maintained at both RX and TX.

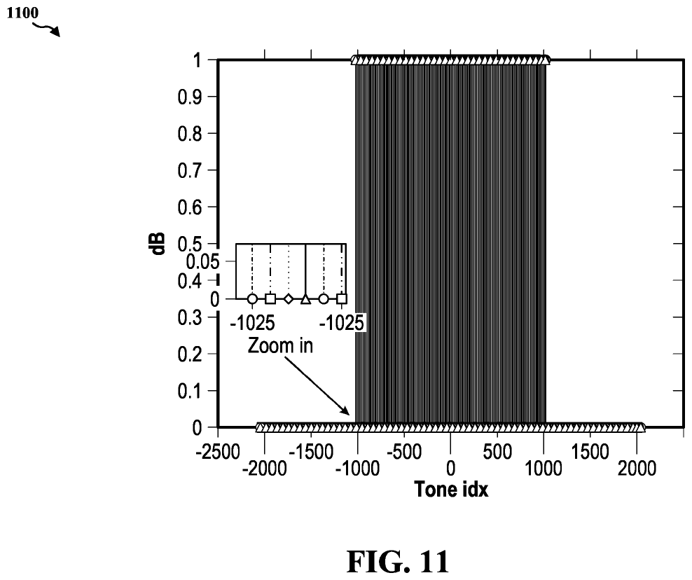

FIG. 11 is a diagram 1100 illustrating an example of different CCs used for FD transmission and reception. As illustrated in FIG. 11, there may be three CCs for RX and one CC for TX that may be placed between the CCs for RX.

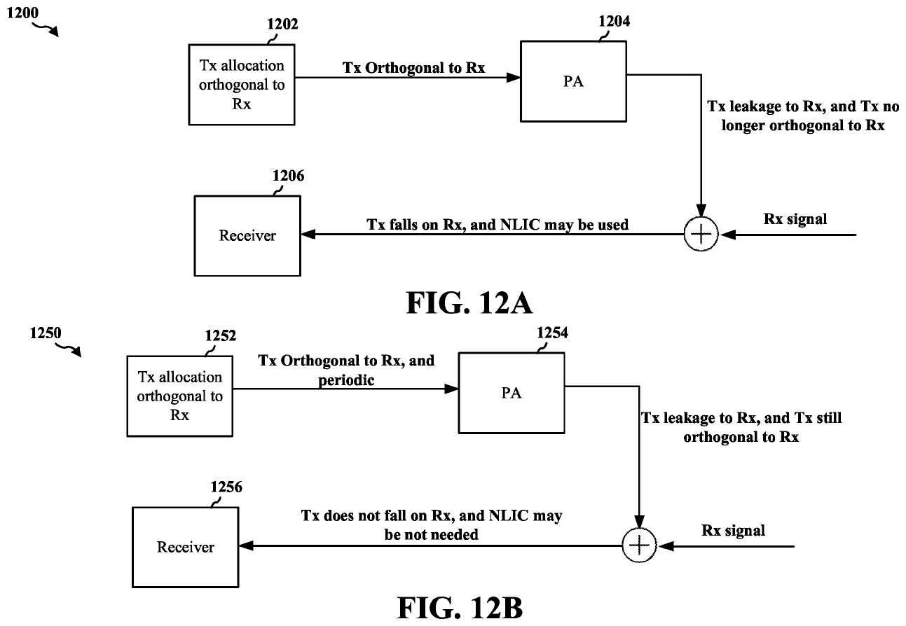

FIG. 12A is a diagram 1200 illustrating an example processing of transmission and reception at a wireless device. At 1202, TX CCs may be allocated such that TX CCs may be orthogonal to RX CCs. At 1204, power amplification (PA) may be performed. After the PA, there may be TX leakage to RX and TX may be no longer orthogonal to RX. Therefore, the TX signal may fall on RX signal and NLIC may be used to mitigate the leakage for the receiver 1206.

FIG. 12B is a diagram 1250 illustrating an example processing of transmission and reception at a wireless device. At 1252, TX CCs may be allocated such that TX CCs may be orthogonal to RX CCs and may be periodic. At 1254, PA may be performed. After the PA, there may be TX leakage to RX and TX may still be orthogonal to RX. Therefore, the TX signal may fall on RX signal and NLIC may be not needed for the receiver 1256.

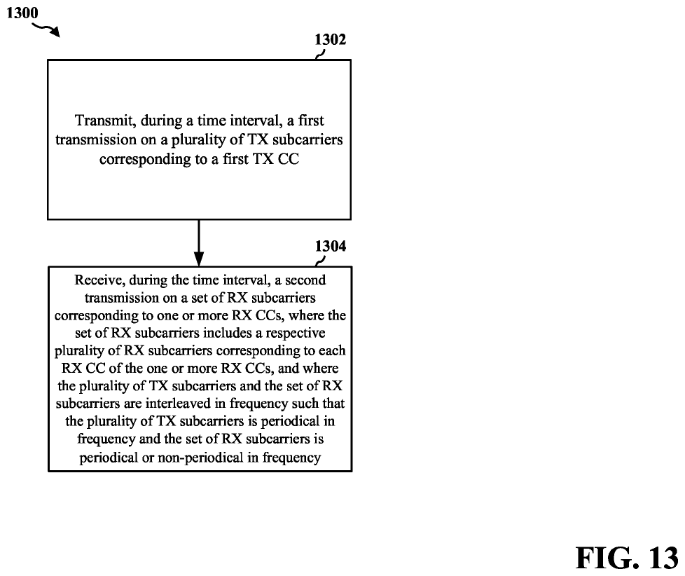

FIG. 13 is a flowchart 1300 of a method of wireless communication. The method may be performed by a first network entity (e.g., the UE 104, the base station 102, the first wireless device 802, the apparatus 1504, the network entity 1502, the network entity 1602, the network entity 1760).

At 1302, the first network entity may transmit, during a time interval, a first transmission on a plurality of TX subcarriers corresponding to a first TX CC. For example, the first wireless device 802 may transmit, during a time interval, a first transmission 806 on a plurality of TX subcarriers corresponding to a first TX CC. In some aspects, 1302 may be performed by FD component 198.

At 1304, the first network entity may receive, during the time interval, a second transmission on a set of RX subcarriers corresponding to one or more RX CCs, where the set of RX subcarriers includes a respective plurality of RX subcarriers corresponding to each RX CC of the one or more RX CCs, and where the plurality of TX subcarriers and the set of RX subcarriers are interleaved in frequency such that the plurality of TX subcarriers is periodical in frequency and the set of RX subcarriers is periodical or non-periodical in frequency. For example, the first wireless device 802 may receive, during the time interval, a second transmission 808 on a set of RX subcarriers corresponding to one or more RX CCs, where the set of RX subcarriers includes a respective plurality of RX subcarriers corresponding to each RX CC of the one or more RX CCs, and where the plurality of TX subcarriers and the set of RX subcarriers are interleaved in frequency such that the plurality of TX subcarriers is periodical in frequency and the set of RX subcarriers is periodical or non-periodical in frequency. In some aspects, 1304 may be performed by FD component 198.

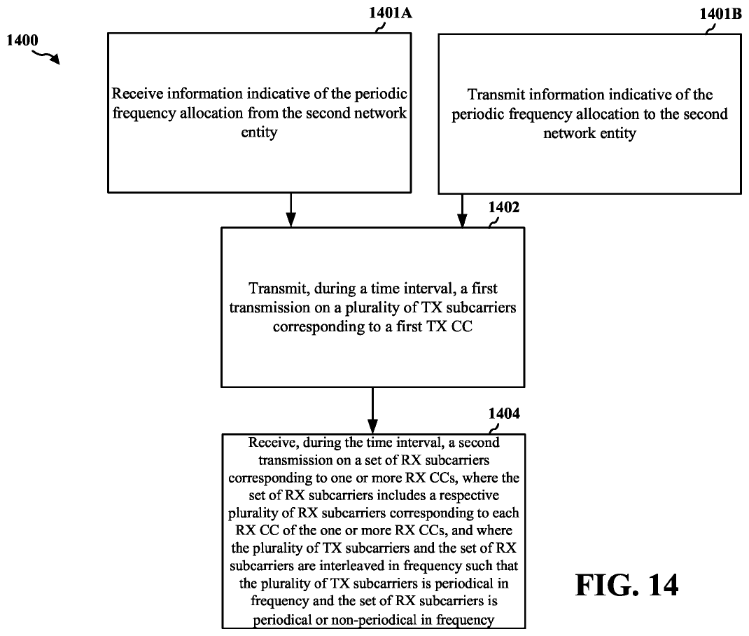

FIG. 14 is a flowchart 1400 of a method of wireless communication. The method may be performed by a first network entity (e.g., the UE 104, the base station 102, the first wireless device 802, the apparatus 1504, the network entity 1502, the network entity 1602, the network entity 1760).

In some aspects, at 1401A, the first network entity may receive information indicative of the frequency allocation from the second network entity. For example, the first wireless device 802 may receive information 805 indicative of the frequency allocation from the second wireless device 804. In some aspects, 1401A may be performed by FD component 198.

In some aspects, at 1401B, the first network entity may transmit information indicative of the frequency allocation to the second network entity. For example, the first wireless device 802 may transmit information 805 indicative of the frequency allocation to the second wireless device 804. In some aspects, 1401B may be performed by FD component 198.

At 1402, the first network entity may transmit, during a time interval, a first transmission on a plurality of TX subcarriers corresponding to a first TX CC. For example, the first wireless device 802 may transmit, during a time interval, a first transmission 806 on a plurality of TX subcarriers corresponding to a first TX CC. In some aspects, 1402 may be performed by FD component 198. In some aspects, the plurality of TX subcarriers and the set of RX subcarriers are interleaved according to a frequency allocation (e.g., the information 805 In some aspects, to transmit the first transmission, the first network entity may transmit the first transmission to a second network entity (e.g., 804) according to the frequency allocation. In some aspects, to transmit the first transmission, the first network entity may configured transmit the first transmission via a power amplifier, and where the frequency allocation enables orthogonality between the first transmission and the second transmission despite use of the power amplifier to transmit the first transmission.

At 1404, the first network entity may receive, during the time interval, a second transmission on a set of RX subcarriers corresponding to one or more RX CCs, where the set of RX subcarriers includes a respective plurality of RX subcarriers corresponding to each RX CC of the one or more RX CCs, and where the plurality of TX subcarriers and the set of RX subcarriers are interleaved in frequency such that the plurality of TX subcarriers is periodical in frequency and the set of RX subcarriers is periodical or non-periodical in frequency. For example, the first wireless device 802 may receive, during the time interval, a second transmission 808 on a set of RX subcarriers corresponding to one or more RX CCs, where the set of RX subcarriers includes a respective plurality of RX subcarriers corresponding to each RX CC of the one or more RX CCs, and where the plurality of TX subcarriers and the set of RX subcarriers are interleaved in frequency such that the plurality of TX subcarriers is periodical in frequency and the set of RX subcarriers is periodical or non-periodical in frequency. In some aspects, 1404 may be performed by FD component 198. In some aspects, to receive the second transmission, the first network entity may receive the second transmission from the second network entity (e.g., 804) according to the frequency allocation. In some aspects, the frequency allocation is configured to preserve orthogonality between the first transmission and the second transmission. In some aspects, according to the frequency allocation, the plurality of TX subcarriers and the set of RX subcarriers are interleaved in frequency such that no two subcarriers of the plurality of TX subcarriers are adjacent. In some aspects, the one or more RX CCs includes a first RX CC, where the respective plurality of RX subcarriers corresponding to the first RX CC is a first plurality of RX subcarriers, and where, according to the frequency allocation, the plurality of TX subcarriers and the set of RX subcarriers are interleaved in frequency such that no two subcarriers of the first plurality of RX subcarriers are adjacent. In some aspects, the one or more RX CCs includes a second RX CC, where the respective plurality of RX subcarriers corresponding to the second RX CC is a second plurality of RX subcarriers, and where, according to the frequency allocation, the plurality of TX subcarriers and the set of RX subcarriers are interleaved in frequency such that no two subcarriers of the second plurality of RX subcarriers are adjacent. In some aspects, where the one or more RX CCs includes a first RX CC, where the respective plurality of RX subcarriers corresponding to the first RX CC is a first plurality of RX subcarriers, and where, according to the frequency allocation, the plurality of TX subcarriers and the set of RX subcarriers are interleaved in frequency such that no two subcarriers of the first plurality of RX subcarriers are adjacent. In some aspects, the one or more RX CCs includes a second RX CC, where the respective plurality of RX subcarriers corresponding to the second RX CC is a second plurality of RX subcarriers, and where, according to the frequency allocation, the plurality of TX subcarriers and the set of RX subcarriers are interleaved in frequency such that no two subcarriers of the second plurality of RX subcarriers are adjacent.

In some aspects, the one or more RX CCs includes a third RX CC, where the respective plurality of RX subcarriers corresponding to the third RX CC is a third plurality of RX subcarriers, and where, according to the frequency allocation, the plurality of TX subcarriers and the set of RX subcarriers are interleaved in frequency such that no two subcarriers of the third plurality of RX subcarriers are adjacent. In some aspects, according to the frequency allocation, the plurality of TX subcarriers and the set of RX subcarriers are interleaved in frequency such that every respective successive two subcarriers of the plurality of TX subcarriers are separated by a respective subset of the set of RX subcarriers, where each respective subset of RX subcarriers includes a respective RX carrier from each respective RX CC of the one or more RX CCs. In some aspects, the one or more RX CCs includes a quantity of RX CCs greater than 1. In some aspects, the quantity of RX CCs equals 3. In some aspects, according to the frequency allocation, the plurality of TX subcarriers and the set of RX subcarriers are interleaved in frequency such that every respective successive two subcarriers of the plurality of TX subcarriers are separated by a respective subset of the set of RX subcarriers, where each respective subset of RX subcarriers includes a single respective RX carrier from each respective RX CC of the one or more RX CCs. In some aspects, the one or more RX CCs includes a quantity of RX CCs greater than 1. In some aspects, the quantity of RX CCs equals 3. In some aspects, the frequency allocation is based on a fast Fourier transform (FFT) size corresponding to the plurality of TX subcarriers and the set of RX subcarriers. In some aspects, the first transmission fully overlaps with the second transmission in a time domain. In some aspects, the first transmission is a first subband full duplex (SBFD) transmission and the second transmission is a second SBFD transmission. In some aspects, the first transmission is an uplink transmission and the second transmission are a downlink transmission. In some aspects, the first transmission is a downlink transmission and the second transmission are an uplink transmission. In some aspects, the first transmission is a first sidelink transmission and the second transmission is a second sidelink transmission. In some aspects, the first transmission is a first backhaul transmission and the second transmission is a second backhaul transmission. In some aspects, the frequency allocation enables the at least one processor to avoid performing a non-linear interference cancellation process to cancel leakage associated with the first transmission on the second transmission.

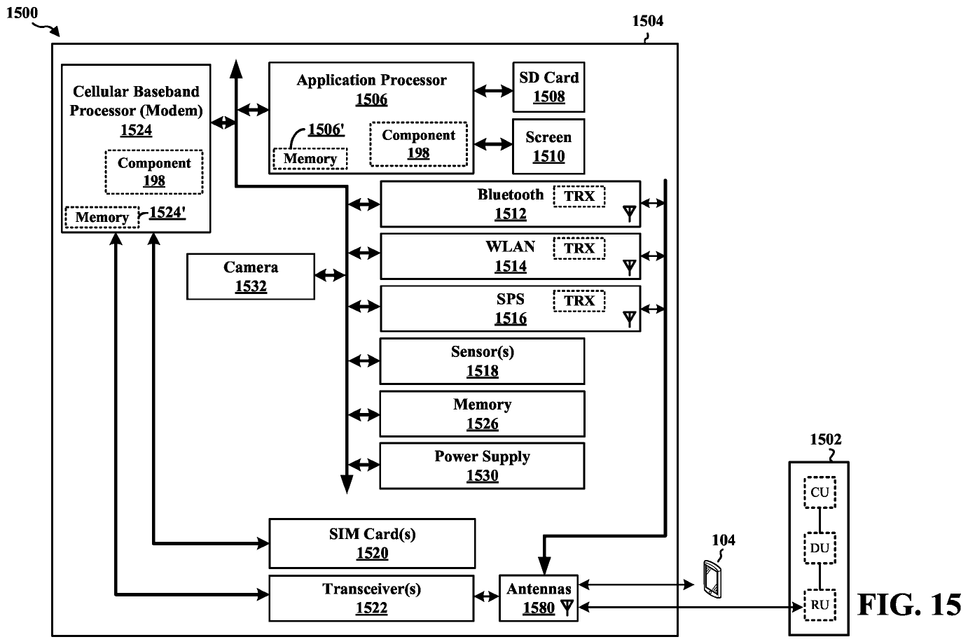

FIG. 15 is a diagram 1500 illustrating an example of a hardware implementation for an apparatus 1504. The apparatus 1504 may be a UE, a component of a UE, or may implement UE functionality. In some aspects, the apparatus 1504 may include a cellular baseband processor 1524 (also referred to as a modem) coupled to one or more transceivers 1522 (e.g., cellular RF transceiver). The cellular baseband processor 1524 may include on-chip memory 1524′. In some aspects, the apparatus 1504 may further include one or more subscriber identity modules (SIM) cards 1520 and an application processor 1506 coupled to a secure digital (SD) card 1508 and a screen 1510. The application processor 1506 may include on-chip memory 1506′. In some aspects, the apparatus 1504 may further include a Bluetooth module 1512, a WLAN module 1514, a satellite system module 1516 (e.g., GNSS module), one or more sensor modules 1518 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1526, a power supply 1530, and/or a camera 1532. The Bluetooth module 1512, the WLAN module 1514, and the satellite system module 1516 may include an on-chip transceiver (TRX)/receiver (RX). The cellular baseband processor 1524 communicates through the transceiver(s) 1522 via one or more antennas 1580 with the UE 104 and/or with an RU associated with a network entity 1502. The cellular baseband processor 1524 and the application processor 1506 may each include a computer-readable medium/memory 1524′, 1506′, respectively. The additional memory modules 1526 may also be considered a computer-readable medium/memory. Each computer-readable medium/memory 1524′, 1506′, 1526 may be non-transitory. The cellular baseband processor 1524 and the application processor 1506 are each responsible for general processing, including the execution of software stored on the computer-readable medium/memory. The software, when executed by the cellular baseband processor 1524/application processor 1506, causes the cellular baseband processor 1524/application processor 1506 to perform the various functions described herein. The computer-readable medium/memory may also be used for storing data that is manipulated by the cellular baseband processor 1524/application processor 1506 when executing software. The cellular baseband processor 1524/application processor 1506 may be a component of the UE 350 and may include the memory 360 and/or at least one of the TX processor 368, the RX processor 356, and the controller/processor 359. In one configuration, the apparatus 1504 may be a processor chip (modem and/or application) and include just the cellular baseband processor 1524 and/or the application processor 1506, and in another configuration, the apparatus 1504 may be the entire UE (e.g., see 350 of FIG. 3) and include the additional modules of the apparatus 1504.

As discussed herein, the FD component 198 may be configured to transmit, during a time interval, a first transmission on a plurality of TX subcarriers corresponding to a first TX CC. In some aspects, the FD component 198 may be further configured to receive, during the time interval, a second transmission on a set of RX subcarriers corresponding to one or more RX CCs, where the set of RX subcarriers includes a respective plurality of RX subcarriers corresponding to each RX CC of the one or more RX CCs, and where the plurality of TX subcarriers and the set of RX subcarriers are interleaved in frequency such that the plurality of TX subcarriers is periodical in frequency and the set of RX subcarriers is periodical or non-periodical in frequency. The FD component 198 may be within the cellular baseband processor 1524, the application processor 1506, or both the cellular baseband processor 1524 and the application processor 1506. The FD component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1504 may include a variety of components configured for various functions. In some aspects, the apparatus 1504 includes means for transmitting, during a time interval, a first transmission on a plurality of TX subcarriers corresponding to a first TX CC. In some aspects, the apparatus 1504 includes means for receiving, during the time interval, a second transmission on a set of RX subcarriers corresponding to one or more RX CCs, where the set of RX subcarriers includes a respective plurality of RX subcarriers corresponding to each RX CC of the one or more RX CCs, and where the plurality of TX subcarriers and the set of RX subcarriers are interleaved in frequency such that the plurality of TX subcarriers is periodical in frequency and the set of RX subcarriers is periodical or non-periodical in frequency. In some aspects, the apparatus 1504 includes means for transmitting information indicative of the frequency allocation to the second network entity. In some aspects, the apparatus 1504 includes means for receiving information indicative of the frequency allocation from the second network entity. In some aspects, the means for transmitting the first transmission includes means for transmitting the first transmission to a second network entity according to the frequency allocation. In some aspects, the means for receiving the second transmission includes means for receiving the second transmission from the second network entity according to the frequency allocation. The means may be the FD component 198 of the apparatus 1504 configured to perform the functions recited by the means. As described herein, the apparatus 1504 may include the TX processor 368, the RX processor 356, and the controller/processor 359. As such, in one configuration, the means may be the TX processor 368, the RX processor 356, and/or the controller/processor 359 configured to perform the functions recited by the means.

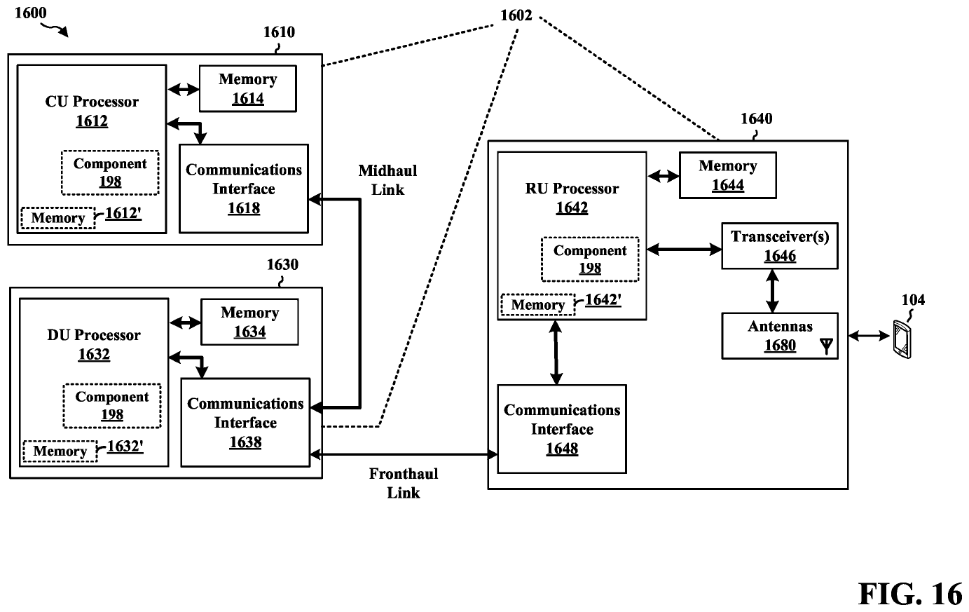

FIG. 16 is a diagram 1600 illustrating an example of a hardware implementation for a network entity 1602. The network entity 1602 may be a BS, a component of a BS, or may implement BS functionality. The network entity 1602 may include at least one of a CU 1610, a DU 1630, or an RU 1640. For example, depending on the layer functionality handled by the component 198, the network entity 1602 may include the CU 1610; both the CU 1610 and the DU 1630; each of the CU 1610, the DU 1630, and the RU 1640; the DU 1630; both the DU 1630 and the RU 1640; or the RU 1640. The CU 1610 may include a CU processor 1612. The CU processor 1612 may include on-chip memory 1612′. In some aspects, the CU 1610 may further include additional memory modules 1614 and a communications interface 1618. The CU 1610 communicates with the DU 1630 through a midhaul link, such as an F1 interface. The DU 1630 may include a DU processor 1632. The DU processor 1632 may include on-chip memory 1632′. In some aspects, the DU 1630 may further include additional memory modules 1634 and a communications interface 1638. The DU 1630 communicates with the RU 1640 through a fronthaul link. The RU 1640 may include an RU processor 1642. The RU processor 1642 may include on-chip memory 1642′. In some aspects, the RU 1640 may further include additional memory modules 1644, one or more transceivers 1646, antennas 1680, and a communications interface 1648. The RU 1640 communicates with the UE 104. The on-chip memory 1612′, 1632′, 1642′ and the additional memory modules 1614, 1634, 1644 may each be considered a computer-readable medium/memory. Each computer-readable medium/memory may be non-transitory. Each of the processors 1612, 1632, 1642 is responsible for general processing, including the execution of software stored on the computer-readable medium/memory. The software, when executed by the corresponding processor(s) causes the processor(s) to perform the various functions described herein. The computer-readable medium/memory may also be used for storing data that is manipulated by the processor(s) when executing software.

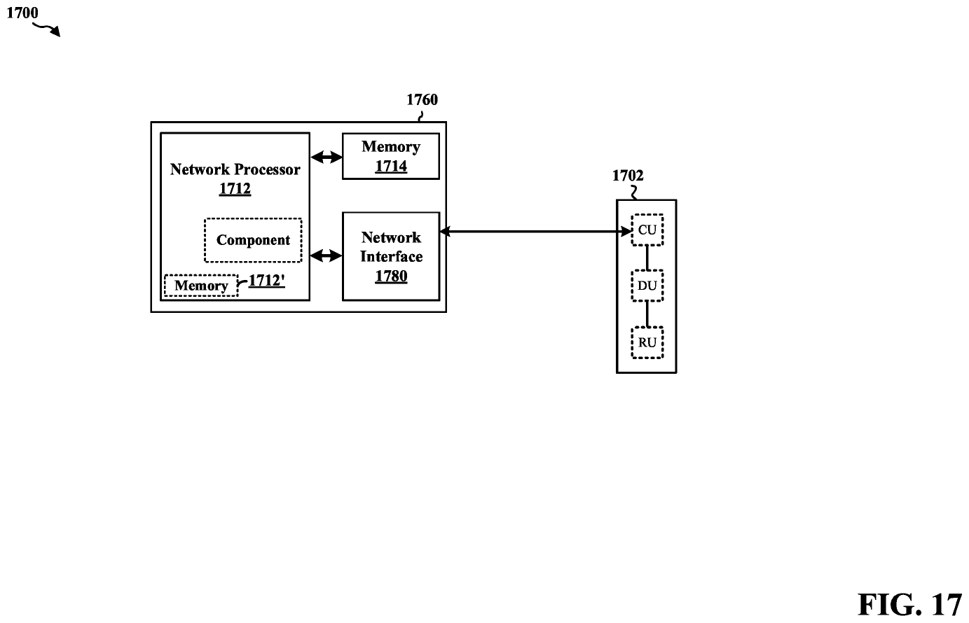

As discussed herein, the FD component 198 may be configured to transmit, during a time interval, a first transmission on a plurality of TX subcarriers corresponding to a first TX CC. In some aspects, the FD component 198 may be further configured to receive, during the time interval, a second transmission on a set of RX subcarriers corresponding to one or more RX CCs, where the set of RX subcarriers includes a respective plurality of RX subcarriers corresponding to each RX CC of the one or more RX CCs, and where the plurality of TX subcarriers and the set of RX subcarriers are interleaved in frequency such that the plurality of TX subcarriers is periodical in frequency and the set of RX subcarriers is periodical or non-periodical in frequency. The FD component 198 may be within one or more processors of one or more of the CU 1610, DU 1630, and the RU 1640. The FD component 198 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1602 may include a variety of components configured for various functions. In some aspects, the network entity 1602 includes means for transmitting, during a time interval, a first transmission on a plurality of TX subcarriers corresponding to a first TX CC. In some aspects, the network entity 1602 includes means for receiving, during the time interval, a second transmission on a set of RX subcarriers corresponding to one or more RX CCs, where the set of RX subcarriers includes a respective plurality of RX subcarriers corresponding to each RX CC of the one or more RX CCs, and where the plurality of TX subcarriers and the set of RX subcarriers are interleaved in frequency such that the plurality of TX subcarriers is periodical in frequency and the set of RX subcarriers is periodical or non-periodical in frequency. In some aspects, the means for transmitting the first transmission includes means for transmitting the first transmission to a second network entity according to the frequency allocation. In some aspects, the means for receiving the second transmission includes means for receiving the second transmission from the second network entity according to the frequency allocation. In some aspects, the network entity 1602 includes means for receiving information indicative of the frequency allocation from the second network entity. In some aspects, the network entity 1602 includes means for transmitting information indicative of the frequency allocation to the second network entity. The means may be the FD component 198 of the network entity 1602 configured to perform the functions recited by the means. As described herein, the network entity 1602 may include the TX processor 316, the RX processor 370, and the controller/processor 375. As such, in one configuration, the means may be the TX processor 316, the RX processor 370, and/or the controller/processor 375 configured to perform the functions recited by the means. FIG. 17 is a diagram 1700 illustrating an example of a hardware implementation for a network entity 1760. In one example, the network entity 1760 may be within the core network 120. The network entity 1760 may include a network processor 1712. The network processor 1712 may include on-chip memory 1712′. In some aspects, the network entity 1760 may further include additional memory modules 1714. The network entity 1760 communicates via the network interface 1780 directly (e.g., backhaul link) or indirectly (e.g., through a RIC) with the CU 1702. The on-chip memory 1712′ and the additional memory modules 1714 may each be considered a computer-readable medium/memory. Each computer-readable medium/memory may be non-transitory. The processor 1712 is responsible for general processing, including the execution of software stored on the computer-readable medium/memory. The software, when executed by the corresponding processor(s) causes the processor(s) to perform the various functions described herein. The computer-readable medium/memory may also be used for storing data that is manipulated by the processor(s) when executing software.

As discussed herein, the FD component 198 may be configured to transmit, during a time interval, a first transmission on a plurality of TX subcarriers corresponding to a first TX CC. In some aspects, the FD component 198 may be further configured to receive, during the time interval, a second transmission on a set of RX subcarriers corresponding to one or more RX CCs, where the set of RX subcarriers includes a respective plurality of RX subcarriers corresponding to each RX CC of the one or more RX CCs, and where the plurality of TX subcarriers and the set of RX subcarriers are interleaved in frequency such that the plurality of TX subcarriers is periodical in frequency and the set of RX subcarriers is periodical or non-periodical in frequency. The FD component 198 may be within the processor 1712. The FD component 198 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1760 may include a variety of components configured for various functions. In some aspects, the network entity 1760 includes means for transmitting, during a time interval, a first transmission on a plurality of TX subcarriers corresponding to a first TX CC. In some aspects, the network entity 1760 includes means for receiving, during the time interval, a second transmission on a set of RX subcarriers corresponding to one or more RX CCs, where the set of RX subcarriers includes a respective plurality of RX subcarriers corresponding to each RX CC of the one or more RX CCs, and where the plurality of TX subcarriers and the set of RX subcarriers are interleaved in frequency such that the plurality of TX subcarriers is periodical in frequency and the set of RX subcarriers is periodical or non-periodical in frequency. In some aspects, the network entity 1760 includes means for receiving information indicative of the frequency allocation from the second network entity. In some aspects, the network entity 1760 includes means for transmitting information indicative of the frequency allocation to the second network entity. In some aspects, the means for transmitting the first transmission includes means for transmitting the first transmission to a second network entity according to the frequency allocation. In some aspects, the means for receiving the second transmission includes means for receiving the second transmission from the second network entity according to the frequency allocation. The means may be the FD component 198 of the network entity 1760 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a first network entity for wireless communication, including: a memory, and at least one processor coupled to the memory, where the at least one processor is configured to: transmit, during a time interval, a first transmission on a plurality of TX subcarriers corresponding to a first TX CC; and receive, during the time interval, a second transmission on a set of RX subcarriers corresponding to one or more RX CCs, where the set of RX subcarriers includes a respective plurality of RX subcarriers corresponding to each RX CC of the one or more RX CCs, and where the plurality of TX subcarriers and the set of RX subcarriers are interleaved in frequency such that the plurality of TX subcarriers is periodical in frequency and the set of RX subcarriers is periodical or non-periodical in frequency.

Aspect 2 is the first network entity of aspect 1, where the plurality of TX subcarriers and the set of RX subcarriers are interleaved in frequency according to a frequency allocation.

Aspect 3 is the first network entity of aspect 2, where, to transmit the first transmission, the at least one processor is configured to transmit the first transmission to a second network entity according to the frequency allocation, where, to receive the second transmission, the at least one processor is configured to receive the second transmission from the second network entity according to the frequency allocation, and where the at least one processor is configured to receive information indicative of the frequency allocation from the second network entity.

Aspect 4 is the first network entity of aspect 2, where, to transmit the first transmission, the at least one processor is configured to transmit the first transmission to a second network entity according to the frequency allocation, where, to receive the second transmission, the at least one processor is configured to receive the second transmission from the second network entity according to the frequency allocation, and where the at least one processor is configured to transmit information indicative of the frequency allocation to the second network entity.

Aspect 5 is the first network entity of any of aspects 2-4, where, to transmit the first transmission, the at least one processor is configured transmit the first transmission via a power amplifier, and where the frequency allocation enables orthogonality between the first transmission after the power amplifier and the second transmission.

Aspect 6 is the first network entity of any of aspects 2-4, where, to transmit the first transmission, the at least one processor is configured transmit the first transmission via a power amplifier, and where the frequency allocation enables orthogonality between the first transmission and the second transmission despite use of the power amplifier to transmit the first transmission.

Aspect 7 is the first network entity of any of aspects 2-6, where the frequency allocation is configured to preserve orthogonality between the first transmission and the second transmission.

Aspect 8 is the first network entity of any of aspects 2-7, where, according to the frequency allocation, the plurality of TX subcarriers and the set of RX subcarriers are interleaved in frequency such that no two subcarriers of the plurality of TX subcarriers are adjacent.

Aspect 9 is the first network entity of aspect 8, where the one or more RX CCs includes a first RX CC, where the respective plurality of RX subcarriers corresponding to the first RX CC is a first plurality of RX subcarriers, and where, according to the frequency allocation, the plurality of TX subcarriers and the set of RX subcarriers are interleaved in frequency such that no two subcarriers of the first plurality of RX subcarriers are adjacent.

Aspect 10 is the first network entity of aspect 9, where the one or more RX CCs includes a second RX CC, where the respective plurality of RX subcarriers corresponding to the second RX CC is a second plurality of RX subcarriers, and where, according to the frequency allocation, the plurality of TX subcarriers and the set of RX subcarriers are interleaved in frequency such that no two subcarriers of the second plurality of RX subcarriers are adjacent.

Aspect 11 is the first network entity of aspect 10, where the one or more RX CCs includes a third RX CC, where the respective plurality of RX subcarriers corresponding to the third RX CC is a third plurality of RX subcarriers, and where, according to the frequency allocation, the plurality of TX subcarriers and the set of RX subcarriers are interleaved in frequency such that no two subcarriers of the third plurality of RX subcarriers are adjacent.

Aspect 12 is the first network entity of aspect 11, where, according to the frequency allocation, the plurality of TX subcarriers and the set of RX subcarriers are interleaved in frequency such that every respective successive two subcarriers of the plurality of TX subcarriers are separated by a respective subset of the set of RX subcarriers, where each respective subset of RX subcarriers includes a respective RX carrier from each respective RX CC of the one or more RX CCs.

Aspect 13 is the first network entity of aspect 12, where the one or more RX CCs includes a quantity of RX CCs greater than 1.

Aspect 14 is the first network entity of aspect 13, where the quantity of RX CCs equals 3.

Aspect 15 is the first network entity of any of aspects 2-14, where, according to the frequency allocation, the plurality of TX subcarriers and the set of RX subcarriers are interleaved in frequency such that every respective successive two subcarriers of the plurality of TX subcarriers are separated by a respective subset of the set of RX subcarriers, where each respective subset of RX subcarriers includes a single respective RX carrier from each respective RX CC of the one or more RX CCs.

Aspect 16 is the first network entity of aspect 15, where the one or more RX CCs includes a quantity of RX CCs greater than 1.

Aspect 17 is the first network entity of aspect 15, where the quantity of RX CCs equals 3.

Aspect 18 is the first network entity of any of aspects 2-17, where the frequency allocation is based on a fast Fourier transform (FFT) size corresponding to the plurality of TX subcarriers and the set of RX subcarriers.

Aspect 19 is the first network entity of any of aspects 1-18, where the first transmission fully overlaps with the second transmission in a time domain.

Aspect 20 is the first network entity of any of aspects 1-19, where the first transmission is a first subband full duplex (SBFD) transmission and the second transmission is a second SBFD transmission.

Aspect 21 is the first network node of any of aspects 1-20, where: the first transmission is an uplink transmission and the second transmission is a downlink transmission; the first transmission is a downlink transmission and the second transmission is an uplink transmission; the first transmission is a first sidelink transmission and the second transmission is a second sidelink transmission; or the first transmission is a first backhaul transmission and the second transmission is a second backhaul transmission.

Aspect 22 is the first network entity of any of aspects 2-21, where the frequency allocation enables the at least one processor to avoid performing a non-linear interference cancellation process to cancel leakage associated with the first transmission on the second transmission.

Aspect 23 is the first network entity of any of aspects 2-21, where, according to the frequency allocation, the plurality of TX subcarriers and the set of RX subcarriers are interleaved in frequency such that the set of RX subcarriers is periodical in frequency.

Aspect 24 is the first network entity of any of aspects 2-21, where, according to the frequency allocation, the plurality of TX subcarriers and the set of RX subcarriers are interleaved in frequency such that the set of RX subcarriers is non-periodical in frequency.

Aspect 25 is a method of wireless communication for implementing any of aspects 1 to 24.

Aspect 26 is an apparatus for wireless communication including means for implementing any of aspects 1 to 25.

Aspect 25 is a computer-readable medium (e.g., a non-transitory computer-readable medium) having code stored thereon that, when executed by an apparatus, causes the apparatus to implement any of aspects 1 to 25.

1. A first network entity for wireless communication, comprising:
a memory', and
at least one processor coupled to the memory, wherein the at least one processor is configured to:
transmit, during a time interval, a first transmission on a plurality of transmission (TX) subcarriers corresponding to a first TX component carrier (CC); and
receive, during the time interval, a second transmission on a set of reception (RX) subcarriers corresponding to one or more RX CCs, wherein the set of RX subcarriers includes a respective plurality' of RX subcarriers corresponding to each RX CC of the one or more RX CCs, and wherein the plurality of TX subcarriers and the set of RX subcarriers are interleaved in frequency such that the plurality of TX subcarriers is periodical in frequency and the set of RX subcarriers is periodical or non-periodical in frequency.

2. The first network entity' of claim 1, wherein the plurality of TX subcarriers and the set of RX subcarriers are interleaved in frequency according to a frequency allocation.

3. The first network entity' of claim 2, wherein, to transmit the first transmission, the at least one processor is configured to transmit the first transmission to a second network entity according to the frequency allocation, wherein, to receive the second transmission, the at least one processor is configured to receive the second transmission from the second network entity according to the frequency allocation, and wherein the at least one processor is configured to receive information indicative of the frequency allocation from the second network entity.

4. The first network entity of claim 2, wherein, to transmit the first transmission, the at least one processor is configured to transmit the first transmission to a second network entity according to the frequency allocation, wherein, to receive the second transmission, the at least one processor is configured to receive the second transmission from the second network entity according to the frequency allocation, and wherein the at least one processor is configured to transmit information indicative of the frequency allocation to the second network entity.

5. The first network entity of claim 2, wherein, to transmit the first transmission, the at least one processor is configured transmit the first transmission via a power amplifier, and wherein the frequency allocation enables orthogonality between the first transmission after the power amplifier and the second transmission.

6. The first network entity of claim 2, wherein, to transmit the first transmission, the at least one processor is configured transmit the first transmission via a power amplifier, and wherein the frequency allocation enables orthogonality between the first transmission and the second transmission despite use of the power amplifier to transmit the first transmission.

7. The first network entity' of claim 2, wherein the frequency allocation is configured to preserve orthogonality between the first transmission and the second transmission.

8. The first network entity' of claim 2, wherein, according to the frequency allocation, the plurality of TX subcarriers and the set of RX subcarriers are interleaved in frequency such that no two subcarriers of the plurality of TX subcarriers are adjacent.

9. The first network entity' of claim 8, wherein the one or more RX CCs includes a first RX CC, wherein the respective plurality' of RX subcarriers corresponding to the first RX CC is a first plurality of RX subcarriers, and wherein, according to the frequency allocation, the plurality of TX subcarriers and the set of RX subcarriers are interleaved in frequency such that no two subcarriers of the first plurality' of RX subcarriers are adjacent.

10. The first network entity' of claim 9, wherein the one or more RX CCs includes a second RX CC, wherein the respective plurality of RX subcarriers corresponding to the second RX CC is a second plurality' of RX subcarriers, and wherein, according to the frequency allocation, the plurality of TX subcarriers and the set of RX subcarriers are interleaved in frequency such that no two subcarriers of the second plurality of RX subcarriers are adjacent.

11. The first network entity of claim 10, wherein the one or more RX CCs includes a third RX CC, wherein the respective plurality of RX subcarriers corresponding to the third RX CC is a third plurality of RX subcarriers, and wherein, according to the frequency allocation, the plurality of TX subcarriers and the set of RX subcarriers are interleaved in frequency such that no two subcarriers of the third plurality' of RX subcarriers are adjacent.

12. The first network entity' of claim 2, wherein, according to the frequency allocation, the plurality of TX subcarriers and the set of RX subcarriers are interleaved in frequency such that every respective successive two subcarriers of the plurality of TX subcarriers are separated by a respective subset of the set of RX subcarriers, wherein each respective subset of RX subcarriers includes a respective RX carrier from each respective RX CC of the one or more RX CCs.

13. The first network entity' of claim 12, wherein the one or more RX CCs includes a quantity of RX CCs greater than 1.

14. The first network entity' of claim 13, wherein the quantity of RX CCs equals 3.

15. The first network entity' of claim 2, wherein, according to the frequency' allocation, the plurality' of TX subcarriers and the set of RX subcarriers are interleaved in frequency such that every respective successive two subcarriers of the plurality' of TX subcarriers are separated by a respective subset of the set of RX subcarriers, wherein each respective subset of RX subcarriers includes a single respective RX carrier from each respective RX CC of the one or more RX CCs.

16-19. (canceled)

20. The first network entity' of claim 1, wherein the first transmission fully overlaps with the second transmission in a time domain.

21. The first network entity of claim 1, wherein the first transmission is a first subband full duplex (SBFD) transmission and the second transmission is a second SBFD transmission.

22. The first network entity of claim 1, wherein:
the first transmission is an uplink transmission and the second transmission is a downlink transmission;
the first transmission is a downlink transmission and the second transmission is an uplink transmission;
the first transmission is a first sidelink transmission and the second transmission is a second sidelink transmission; or
the first transmission is a first backhaul transmission and the second transmission is a second backhaul transmission.

23. The first network entity' of claim 2, wherein, according to the frequency allocation, the plurality' of TX subcarriers and the set of RX subcarriers are interleaved in frequency such that the set of RX subcarriers is periodical in frequency.

24. The first network entity of claim 2, wherein, according to the frequency allocation, the plurality of TX subcarriers and the set of RX subcarriers are interleaved in frequency such that the set of RX subcarriers is non-periodical in frequency.

25-30. (canceled)
